(19) United States
(12) Patent Application Publication
(10) Pub. No.: US 2005/0251339 A1
(43) Pub. Date: Nov. 10, 2005

(54) Methods and systems for monitoring environments

(75) Inventors: M. Sam Araki, Saratoga, CA (US); Peter Coe-Verbica, Santa Cruz, CA (US); Ashim Banerjee, Westminster, CO (US); Safwan Shah, San Jose, CA (US); Mobeen Bajwa, Fremont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ST- Infonox, Campbell, CA (US)

(21) Appl. No.: 10/839,980

(22) Filed: May 5, 2004

(51) Int. Cl. G06F 11/00

(52) U.S. Cl. 702/2; 702/188

(57) ABSTRACT

Methods and systems are provided for monitoring a state of an environment. Sensors are distributed spatially within the environment, with each sensor measuring one of the measured parameters at its spatial location. A controller receives data collected from each of the sensors. The controller identifies the occurrence of an event at at least one of the sensors. The controller extracts derived parameters from the collected data. The controller determines a cross-correlation of the extracted parameters over the sensors. The controller identifies an abnormality in the environment from the determined cross-correlation.

### BACKGROUND OF THE INVENTION

This application relates generally to methods and systems for monitoring environments. More specifically, this application relates to methods and systems that identify correlations among different measurements to monitor environments.

The quality of many types of environments, whether they be small or large, is dictated by a complex interaction among a variety of different parameters. This is readily apparent for many large environments, such as where the environment is defined by the quality of air, water, and food sources in a country. But it is also true of smaller environments, such as where the environment is defined by the quality of water delivered to a residential apartment building. In either case, these qualities may be defined by a number of different parameters and degradation of the quality of the environment may be reflected by changes in any of the parameters. Identification of a notable change in the environment has often traditionally been accomplished by looking at one such parameter to determine whether it obtains a value that is outside a predefined “normal” range for the parameter. For example, in a case where the environment is defined by the air quality within a bedroom, a smoke detector may monitor air-clarity levels, sounding an alarm when the air-clarity levels drop below a predefined threshold.

In some instances, this approach is extended so that multiple parameters are monitored, with some action being taken when the combination of parameters falls outside a predefined “normal” set of values for the combination of parameters. In effect, such approaches define a volume within a parameter space that defines “normal” operation, so that the action is taken only when the combination of parameters lies outside the defined volume. For example, in a case where the environment is defined by the presence or absence of fire in a room, two parameters may be used such as the temperature within the room and the air-clarity level in the room. When the combination of these parameters falls outside a defined “normal” area in the two-dimensional parameter space, a fire alarm may be triggered. By requiring such a combination, it is possible that an elevation in temperature to T₁ alone might not trigger the alarm unless it is accompanied by a decrease in air clarity that is inferred to indicate the presence of smoke. The defined area may, however, specify that certain temperatures above, say, T₂ always trigger the alarm irrespective of air-clarity measurements. Similarly, some decreases in air clarity alone may be tolerable if they are not accompanied by temperature increases, although the defined are threshold values may effectively specify a threshold air clarity below which the alarm is triggered regardless of the temperature.

Such multidimensional approaches are valuable in that they account for more than a single parameter, but remain limited by the fact that they are still sensitive only to relatively large changes in the parameters. These approaches generally view relatively small changes in parameters as statistically insignificant—i.e. as due to normal random fluctuations in the parameters. But when relatively small changes, even those that are individually below the average noise level for a given parameter, point predominantly in a consistent direction, they may correspond to a real environment change. There is accordingly a need in the art for improved methods and systems for monitoring environments that are capable of accounting for such changes.

### BRIEF SUMMARY OF THE INVENTION

Methods and systems are thus provided for monitoring a state of an environment. The state is defined by a plurality of measured parameters. In one embodiment, a plurality of sensors are distributed spatially within the environment. Each sensor is adapted to measure one of the measured parameters at its spatial location within the environment. A controller is provided in communication with the sensors and has programming instructions to perform a number of functions. The controller receives data collected from each of the sensors. The controller identifies the occurrence of an event at at least one of the sensors by identifying a change in an event-defining parameter. The controller extracts a plurality of derived parameters from the collected data. The controller determines a cross-correlation of the extracted plurality of derived parameters over the plurality of sensors. The controller identifies an abnormality in the environment from the determined cross-correlation.

In some embodiments, the event-defining parameter is the parameter measured at the at least one of the sensors. In other embodiments, the event-defining parameter is derived from the parameter measured at the at least one of the sensors. The plurality of derived parameters may each have a time dependence. In such instances, the controller may further have programming instructions to apply fuzzy logic to the time dependence of each of the derived parameters prior to determining the cross-correlation of the extracted plurality of derived parameters. In other instances, the plurality of measured parameters may be time-period correlatable. In such instances, the programming instructions to extract the plurality of derived parameters may comprise programming instructions to calculate an autocorrelation of each of the plurality of measured parameters. In still other instances, the plurality of derived parameters may comprise a mean and standard deviation over time of the plurality of measured parameters.

The environment may comprise a hierarchical branching network with the plurality of sensors distributed throughout the hierarchical branching network. For example, in one embodiment, the environment comprises a fluid-distribution system and the hierarchical branching network comprises a network of branching channels through which fluid flows. In such an embodiment, the plurality of measured parameters may comprise a quantity selected from the group consisting of a turbidity, a pH level, a conductivity, and a concentration of solids dissolved in the fluid. In another embodiment, the environment comprises a power-distribution system and the hierarchical branching network comprises a network of branching power-distribution lines.

The controller may include programming instructions to determine a severity of the abnormality from the determined cross-correlation. In such cases, the controller may also include programming instructions to initiate an alarm in accordance with the determined severity of the abnormality. In some cases, the environment may also be one of a plurality of environments, each having a state monitored by the system. The controller may then have programming instructions to correlate abnormalities identified in each of the environments.

### BRIEF DESCRIPTION OF THE DRAWINGS

A further understanding of the nature and advantages of the present invention may be realized by reference to the remaining portions of the specification and the drawings wherein like reference labels are used throughout the several drawings to refer to similar components. In some instances, reference labels include a numerical portion followed by a latin-letter suffix; reference to only the numerical portion of reference labels is intended to refer collectively to all reference labels that have that numerical portion but different latin-letter suffices.

FIG. 1 provides a schematic diagram presenting an overview of a system in one embodiment of the invention;

FIG. 2 provides a schematic diagram illustrating an arrangement of sensors that may be used to collect data for monitoring environments in an embodiment of the invention;

FIG. 3 is a flow diagram illustrating a method for monitoring environments in an embodiment of the invention;

FIG. 4 provides an illustration of modules used in a system for monitoring environments in an embodiment;

FIGS. 5A and 5B provide illustrations of collected data and derived parameters used in monitoring environments in embodiments of the invention;

FIG. 6 provides a schematic diagram illustrating an arrangement of modules for combining information from different types of measurements in monitoring an environment;

FIG. 7 provides a schematic diagram illustrating an arrangement of modules for monitoring multiple environments in an embodiment of the invention; and

FIG. 8 provides a structural illustration of a computer system on which modules used by the invention may be embodied.

### DETAILED DESCRIPTION OF THE INVENTION

Embodiments of the invention provide methods and systems for monitoring environments. As used herein, the term “environment” is intended to be construed broadly as encompassing any system having states defined by a plurality of parameters; in some instances, the states of the environment may depend on interactions among physical qualities characterized by corresponding values of the parameters. For example, in one embodiment, the environment may be a physical environment, which has states defined by such parameters as measures of temperature, chemical composition, humidity, air pressure, and the like. Such a physical environment may have multiple components, so that the physical qualities characterized by such measured parameters interact to produce measures of water quality, air quality, food quality, and the like. In another embodiment, the environment may be a distribution environment, such as a fluid-distribution environment, power-distribution environment, or the like. States of a fluid-distribution environment used to provide fluids like water to customers may be defined by parameters such as turbidity, pH, conductivity, concentration of dissolved solids, and the like at different points in the distribution system. Similarly, a power-distribution environment may have states defined by parameters such as power-consumption levels at different points, usage fluctuations at different points, the status of power-generating facilities within the system, and the like.

Merely by way of example, other environments that may be monitored with embodiments of the invention include transportation environments, which may have states defined by traffic flow rates on road systems, traffic flow rates on rail systems, traffic flow rates on water-transportation systems, and the like. An emergency-status environment may have states defined by admission levels in emergency rooms in an area, drug-distribution levels by pharmacies in the area, dispatch levels for police officers in the area, dispatch levels for ambulances in the area, dispatch levels for firefighters in the area, and the like. An immigration-status environment may have states defined by foreign-national entry levels at different entry points of a country, including air and sea ports, foreign-national exit levels at different exit points of the country, and the like. These examples of environments that may be monitored with the systems and methods of the invention are intended to be illustrative and not limiting. As discussed in further detail below, monitoring results from these environments may be combined in some embodiments, allowing conclusions to be drawn from correlations of states in the different environments. In such an embodiment, each of the environments may thus be considered to be a subenvironment comprised by a larger environment, with states of the larger environment being defined in terms of the parameters discussed in connection with each of the subenvironments.

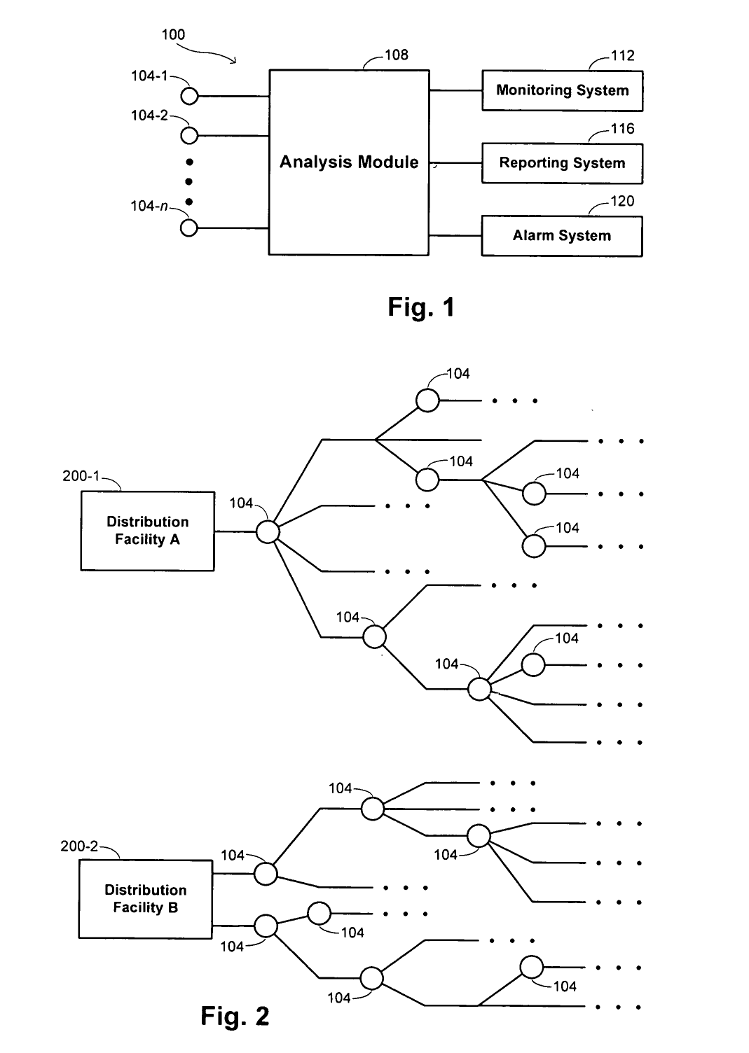

A general overview of a system of the invention in one embodiment is provided in FIG. 1. An analysis module 108 is equipped to receive data from a plurality of sensors 104 distributed within the environment. The type of data collected by the sensors 104 and provided to the analysis module 108 may depend on what parameters are used to define states of the parameters. For instance, in an embodiment where the environment is a physical environment defined by temperature, humidity, and air pressure, the sensors may comprise thermometers, hygrometers, and barometers distributed throughout the physical environment. Interfaced with the analysis module 108 may be monitoring systems 112, reporting systems 116, and/or alarm systems 120. The monitoring systems 112 allow real-time oversight of the state of the environment, with the reporting systems 116 permitting an account of a time evolution of the state to be provided and the alarm systems 120 permitting a notification to issued upon detection that the environment is in an undesirable state.

The distribution of the sensors 104 may depend on specific characteristics of the environment states that are to be measured, but it is generally desirable that they be distributed throughout the environment so that the parameter values may be determined in a manner that allows characterization of the entire environment. For instance, in many embodiments, the environment may have a hierarchical network structure so that the sensors are distributed at different points in the hierarchy of the network. One example where this is particularly true is in cases where the environment comprises one or more distribution environments. In FIG. 2, for example, a distribution facility 200 may provide drinking water or power for distribution to consumer homes through a branching network. The sensors 104 may be positioned at different points within the branching network so that measurements of the parameters defining the environment may be made throughout the network. As illustrated in FIG. 2, the environment may comprise a plurality of such networks originating at different distribution facilities 200. In some instances, the distribution facilities may provide the same thing, i.e. drinking water or power, but are configured to distribute it to different end consumers. In other embodiments, the distribution facilities 200 may provide different things, such as where distribution facility A 200-1 provides drinking water and distribution facility B 200-2 provides power. In such instances, there may be many common end users for the different networks, and the end users may even be identical.

Such branching networks conveniently illustrate the limitations with relying on individual sensor measurements to identify changes in an environment, and the improved understanding possible with embodiments of the invention. For instance, with a drinking-water-distribution environment, the sensors might comprise devices that measure and quantify parameters such as turbidity, pH, conductivity, concentration of certain dissolved solids, and the like. Each instrument makes measurements at a specific point in the fluid stream as a function of time. Thus, a turbidity meter may record the turbidity of the fluid stream flowing through the meter as a function of time. While small changes in the turbidity in one channel may be lost as noise in the normal fluctuations in one parameter, a derived parameter that combines measurements from multiple sensors provides a signal that is smoothed out by an increase in signal-to-noise ratio. Generally, this signal-to-noise ratio improves as the square root of the number of points in the measurement so that a derived parameter that combines 100 points of measurement would have a signal-to-noise ratio that is about ten times better than that observed an any individual measurement point.

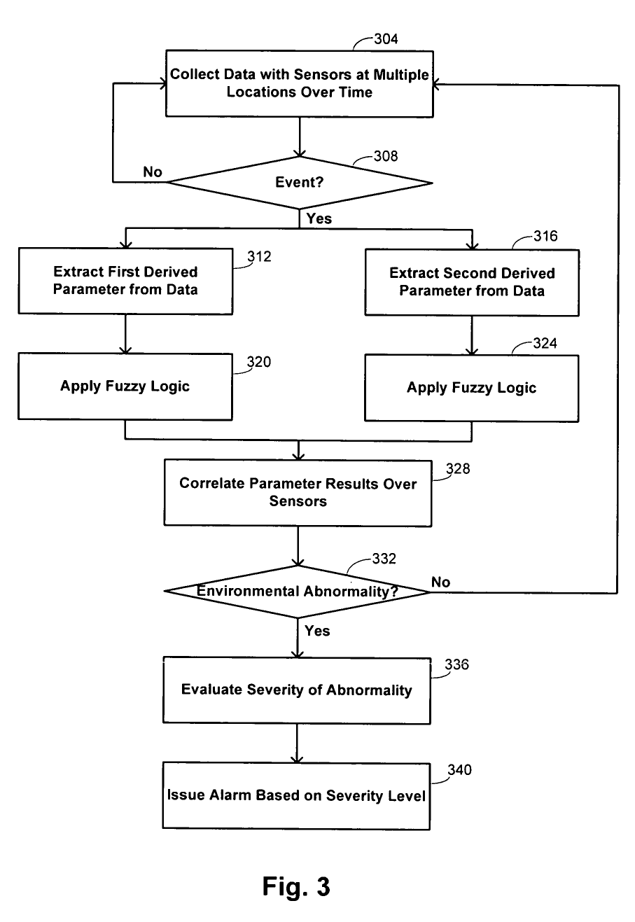

FIG. 3 provides a flow diagram that illustrates a specific embodiment for monitoring an environment in accordance with this principle. As data are collected with multiple distributed sensors at block 304, they are evaluated for the identification of an “event,” which is defined by a predetermined rule and which is designated to occur at a time that conditions specified by the predetermined rule are satisfied. The predetermined rule may define an event in terms of a single sensor measurement, such as where an event occurs whenever the turbidity in a fluid stream exceeds 80 mNTU. Alternatively, the predetermined rule may define an event in terms of a combination of multiple sensor measurements, such as where an event occurs whenever the average turbidity of a fluid stream within a 50-m length of the distribution environment exceeds 65 NTU. In some instances, the event may be defined in terms of multiple parameters, such as where an event occurs when both the turbidity at a certain point in a fluid stream exceeds 70 NTU and the pH of the fluid within 5 meters of that point is less than 6.0.

Upon identification that an event has occurred, multiple derived parameters are extracted from the data. The specific derived parameters that are extracted may depend on the nature of the data. In some embodiments, for example, the derived parameters may include the mean and/or standard deviation of the collected data for a particular measured parameter derived over a small time interval. In instances where the data comprise time-period correlatable data, the derived parameters may comprise autocorrelation parameters. The results of an autocorrelation calculation may be fitted to a curve having a generic shape, with the fit coefficients acting as the derived parameters.

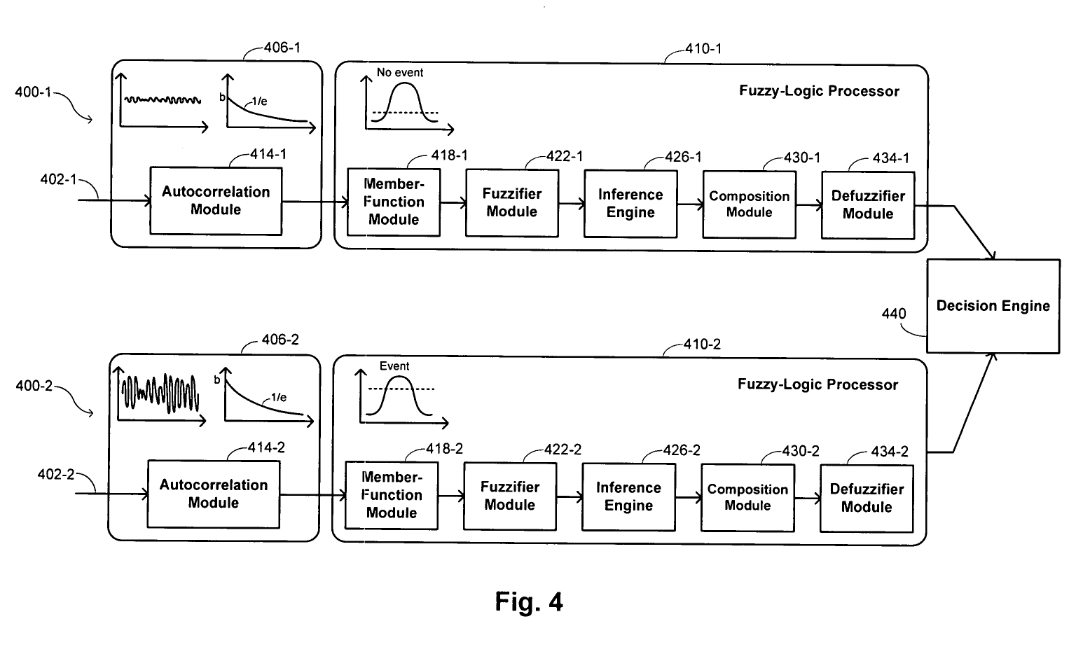

As indicated at blocks 312 and 316, such derived parameters are determined for at least two different quantities X₁ and X₂. For instance, in the fluid-distribution example, autocorrelation parameters derived for the turbidity and the pH may be used as the derived parameters. In some embodiments, more than two derived parameters may be used, as noted below. A cross-correlation of the derived parameters is calculated at block 328, and may be preceded by the application of fuzzy-logic as part of the derived parameter extractions at blocks 320 and 324. Further details of the fuzzy-logic application are described below in connection with FIG. 4. The cross-correlation between derived parameters X₁ and X₂ may be calculated as

$${R}_{{X}_{1} {X}_{2}} = \frac{{\sum }_{i} ( {X}_{1}^{( i )} - {\overline{X}}_{1} ) {\sum }_{j} ( {X}_{2}^{( j )} - {\overline{X}}_{2} )}{{σ}_{{X}_{1} {X}_{2}}} ,$$

where the mean of Xₖ (k=1, 2) is given over the set of N sensors as

$${\overline{X}}_{k} = \frac{1}{N} {\sum }_{i} {X}_{k}^{( i )}$$

and the standard deviation of Xₖ is given by

$${σ}_{{X}_{k}} = \sqrt{\frac{{\sum }_{i} {( {X}_{k}^{( i )} - {\overline{X}}_{k} )}^{2}}{N - 1}} .$$

In these calculations, the correlations are calculated over multiple sensors identified by index i. The correlation determinations are generally performed over a greater number of sensors distributed within the environment than were used to identify the occurrence of the event. Usually, the number of sensors over which the correlations are determined is at least ten times the number of sensors used in identifying the event, but may be smaller than ten times in some instances. In some embodiments, the correlation determinations are made from data collected at all sensors provided within the environment. In embodiments that use more than two derived parameters, the correlation may be determined in a manner analogous to the two-parameter cross-correlation function described above as

$${R}_{{X}_{1} {X}_{2} … {X}_{M}} = \frac{{\prod }_{m = 1}^{M} {\sum }_{i} ( {X}_{m}^{( i )} - {\overline{X}}_{m} )}{{\prod }_{m = 1}^{M} {σ}_{{X}_{m}}} .$$

The results of the correlation determination are used at block 332 to evaluate whether the state of the environment has an abnormality. Such a determination may rely on whether the calculated correlation value is within a predefined range that specifies whether that the state of the environment is considered to be normal. If an abnormality is detected, the severity of the abnormality may be evaluated at block 336, such as by determining the degree to which the calculated correlation value is outside the predefined normal range. An alarm may be issued at block 340 based on the determined severity level. For example, a level of urgency associated with the alarm (e.g., yellow, orange, red, . . . ) may depend on how far outside the predefined normal range the calculated correlation value is.

In the above description, the calculations of correlation results have treated all sensors equally. In other embodiments, different weighting factors wᵢ may be applied to each of the sensors so that in the above calculations Xₘ⁽ⁱ⁾→wᵢXₘ⁽ⁱ⁾. The weighting factors wᵢ may reflect a determination that the information content provided by data from certain sensors is more relevant in identifying abnormal environments that the data from other sensors. The assignment of weighting factors may thus be an adaptive process in which the weighting factors are adjusted periodically on the basis of obtained versus desired results. Such backpropagation may be implemented using backpropagation neural networks or some similar design known to those of skill in the art.

The methods by which the derived parameters are extracted in one embodiment and by which fuzzy logic is applied prior to calculation of the cross-correlation may be more clearly understood with reference to FIG. 4. This figure shows a set of modules that may be used in performing the calculations at blocks 312, 316, 320, and 324 of FIG. 3. The modules are organized into two sets 400-1 and 400-2, respectively corresponding to measured parameters x₁ and x₂. Each set of modules includes a derived-parameter extraction module 406 and a fuzzy-logic processor 410, which respectively perform the functions of blocks 312/316 and 320/324. In the illustrated embodiment, the derived-parameter extraction modules 406 comprise autocorrelation modules 414 suitable when the incoming data 402 to the modules comprises time-period correlatable data; in other embodiments, modules that extract different derived parameters, such as the mean and/or standard variation may be used. The autocorrelation module 414 converts measured incoming time-dependent data, represented by the left graph within the module box, to a time-dependent curve characterized by extracted parameters, represented by the right graph within the module box. In this instance, the derived parameters are defined as b and 1/e, which characterize an exponentially decaying function. Incoming data 402-1 may correspond to data x₁ and incoming data 402-2 may correspond to data x₂, so that the derived parameters b and 1/e differ along the two pathways. In this illustration, the particular characteristics of incoming data 402-2 define an event so that the character of b and 1/e for that data are different than for similar parameters derived from incoming data 402-1.

The converted time-dependent data are fed to the fuzzy-logic processor 410, which may include a number of modules for implementing fuzzy-logic techniques. Fuzzy logic generally includes a number of methods that allow decision-making processes to be implemented with inexact information, particular where ambiguities in the information are nonstatistical in nature. By applying fuzzy logic, the contribution of a set of information to various parameters may be quantified. Fuzzy logic may generally be viewed as a superset of Boolean logic in which Boolean truth values may be replaced with intermediate degrees of truth. Thus, while Boolean logic allows only for truth values of zero and one, fuzzy logic allows for truth values having any real number between zero and one.

The application of fuzzy logic may begin with a member-function module 418 that determines the degree of membership of a crisp value from the converted data into one or more fuzzy sets. The number of fuzzy sets that are used may depend on the type of environment being monitored and/or on the nature of the measured parameters being considered. A fuzzifier module 422 comprises if-then rules that act to fuzzify the data. The inference engine 426 and composition module 430 apply rules for activation and combination that map fuzzy sets into other fuzzy sets. A defuzzifier module 434 converts the resulting fuzzy sets into crisp values that may be used by a decision engine 440 to determine whether the environment has an abnormality as described above. The application of fuzzy-logic techniques is well known to those of skill in the art and is described in further detail in, for example, U.S. Pat. No. 5,307,443, entitled “APPARATUS FOR PROCESSING INFORMATION BASED ON FUZZY LOGIC,” the entire disclosure of which is incorporated herein by reference for all purposes. Also, the use of fuzzy-logic techniques is not necessary in practicing the invention, which may be practiced using a variety of alternative artificial-intelligence techniques in other embodiments, including expert systems, neural networks, genetic algorithms, and the like.

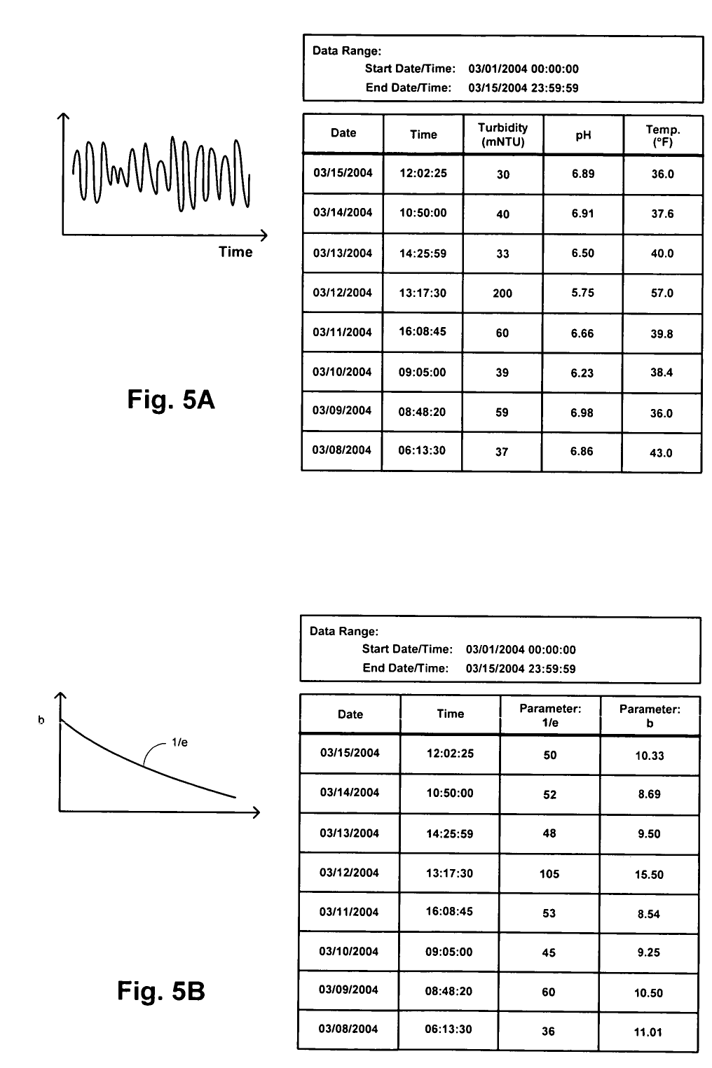

A specific example is provided in FIGS. 5A and 5B for an embodiment where the environment comprises a fluid-distribution environment. In FIG. 5A, data are collected over a period of time for one of the sensors, with some of the results being shown for the turbidity, pH, and temperature, as examples of three measured parameters that may be collected. The highlighted entries show an example that may correspond to the occurrence of an event, where the turbidity exceeds a specified level, the pH is lower than a specified level, or the temperature is greater than a specified level. These deviations may be manifested also in the derived parameters, as shown in FIG. 5B. In this instance, the derived parameters 1/e and b have relatively large values that are incorporated into the determination of the cross correlation when the environment is evaluated over multiple sensors.

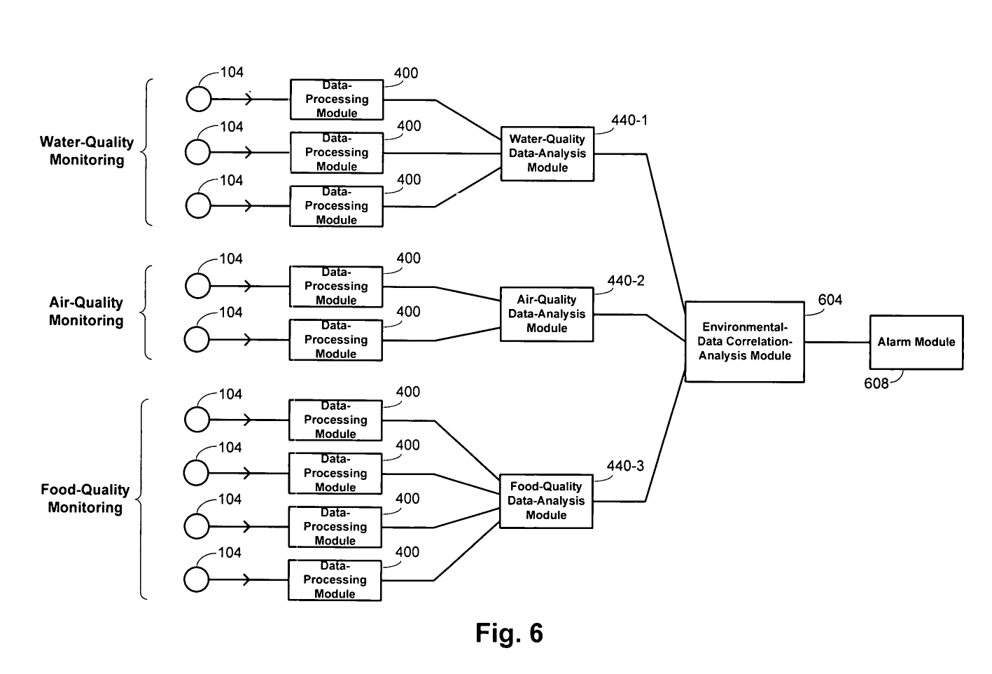

The basic structure of the environment-monitoring system may be built up to allow monitoring of increasing complex environments. For example, the structure shown in FIG. 4 for monitoring, say, a water-distribution environment may be duplicated for an air-quality monitoring environment and a food-quality monitoring environment. Each of these may include sensors suitable for measuring parameters that allow evaluation of a state of the respective environments, and the determinations may be correlated to monitor an overall state of an environment that includes the water-distribution, air-quality, and food-quality environments as sub-environments. This is illustrated in FIG. 6, in which three distinct modules 440 are supplied for making decisions regarding the respective sub-environments. Water-quality data-analysis module 440-1 receives data from a plurality of data-processing modules 400 that are derived from different types of underlying measured data relevant to water quality. Each of these data-processing modules 400 may use the autocorrelation and fuzzy-logic techniques described above in providing information for analysis by the water-quality data-analysis module 440-1. Similarly, an air-quality data-analysis module 440-2 receives data from a plurality of data-processing modules 400 that process data relevant to air quality and a food-quality data-analysis module 440-3 receives data from a plurality of data-processing modules 400 that process data relevant to food quality.

The conclusions drawn by the water-quality, air-quality, and food-quality modules are provided to an environmental-data correlation-analysis module 604 that combines the information in a fashion similar to that described above for the individual sub-environments. The determinations resulting from this module provide a measure of a state of a physical environment that includes the water-quality, air-quality, and food-quality environments as sub-environments. In some embodiments, an alarm module 608 may be provided in communication with the environmental-data correlation-analysis module to issue an alarm if the state of the physical environment is abnormal, with the alarm module being equipped to provide different alarms to represent different levels of abnormality. For example, an abnormality manifested only in one of the sub-environments may warrant an alarm that suggests a infrastructure defect, while an abnormality manifested in all sub-environments may indicate a higher risk of a coordinated attack on the physical environment.

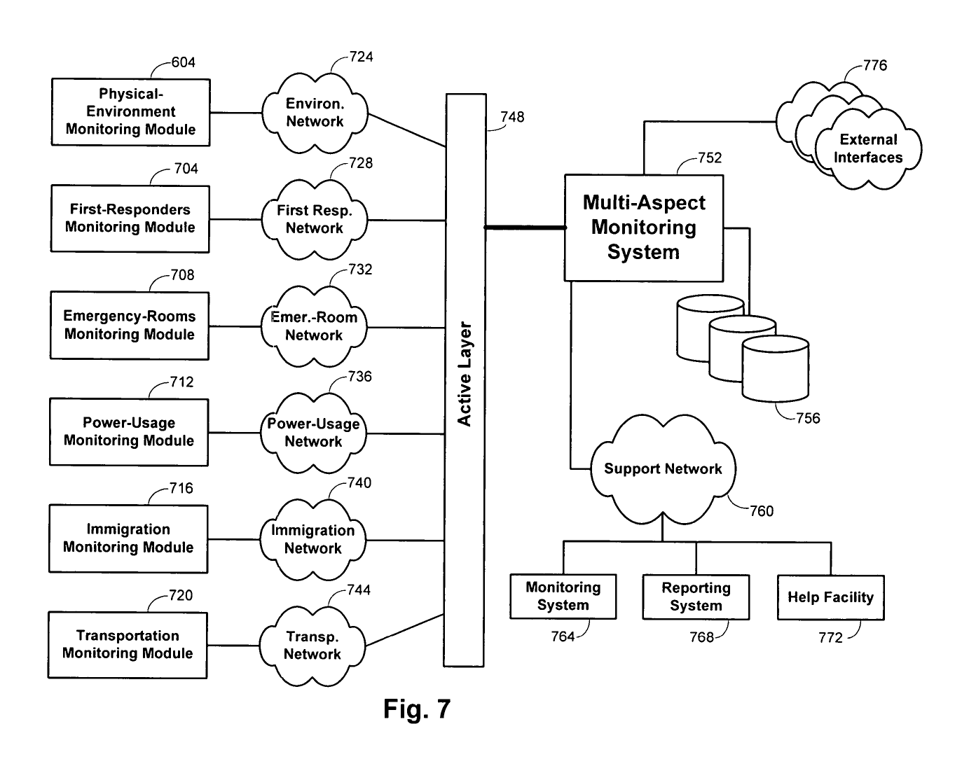

The same principle may be extended to higher hierarchical levels as indicated in FIG. 7. In this embodiment, the physical-environment monitoring module 604 is one of a plurality of monitoring modules that monitor distinct environments. For instance, these environments may correspond to those described above and may include a first-responders monitoring module 704, an emergency-room monitoring module 708, a power-usage monitoring module 712, an immigration monitoring module 716, a transportation monitoring module 720, and the like. Each of the monitoring modules may make use of information derived from sub-environment data, examples of which were provided above, and the sub-environment data itself may reflect conclusions drawn from different types of measurements performed by the sensors.

In order to coordinate all of this disparate information for different environments in a meaningful way, a plurality of networks may be provided that interface with each of the different monitoring modules. Thus, a physical-environment network 724 interfaces with the physical-environment monitoring module 604, a first-responders network 728 interfaces with the first-responders monitoring module 704, an emergency-room network 732 interfaces with the emergency-room monitoring module 708, a power-usage network interfaces with the power-usage monitoring module 712, an immigration network 740 interfaces with the immigration-monitoring module, and a transportation network 744 interfaces with the transportation monitoring module. Because of the different character of the environments, each of these networks generally lacks access to information available to the other networks.

Accordingly, an intermediate active layer 748 may be provided to allow both coordination of information accessible over the different networks and to allow a single monitoring system 752 to be used in performing monitoring functions for each of the environments. The active layer 748 comprises a suite of server and client resident software that enables data collection and event detection in real time in an adaptable fashion, and is described in further detail for other applications in copending U.S. patent application Ser. No. 09/871,996, the entire disclosure of which is incorporated herein by reference for all purposes. The active layer 748 also provides a mechanism by which adjusted weighting factors may be backpropagated to the monitoring modules to improve their generation of results. The multi-aspect monitoring system 752 may function in some embodiments to provide a monitoring function for each of the distinct environments separately. In other embodiments, the multi-aspect monitoring system 752 may instead perform correlation functions on data for the different environments in the same fashion described above so that the individual environments are treated as sub-environments within a larger environment.

The multi-aspect monitoring system also acts an interface through which additional functionality may be provided. For example, information maintained by the multi-aspect monitoring system on databases 756 may be accessed or provided from external interfaces 778. In addition, the multi-aspect monitoring system 752 may be interfaced with a support network 760 that allows monitoring services to be provided to customers. For example, a water-distribution company might contract to have its water-supply network monitored so that abnormalities in the quality of water being provided to its own customers may be detected early. Similarly, a commercial-building landlord might contract to have various systems in the building monitored, such as water systems, sewage systems, heating/cooling systems, and the like. At a larger scale, governmental authorities might contract to have a variety of systems that define a city environment, state environment, or even national environment monitored. Such monitoring may allow the governmental authority to identify disruptions in the environment that may result from natural disasters, industrial accidents, terrorist attacks, and the like more quickly. The support network 760 may thus be interfaced with a monitoring system that provides monitoring personnel with environment-state conclusions derived by the multi-aspect monitoring system 752, a reporting system 768 that generates periodic reports for customers regarding the state of the environment, and a help facility 772 that allows customers access to make inquires about the results or operation of the system.

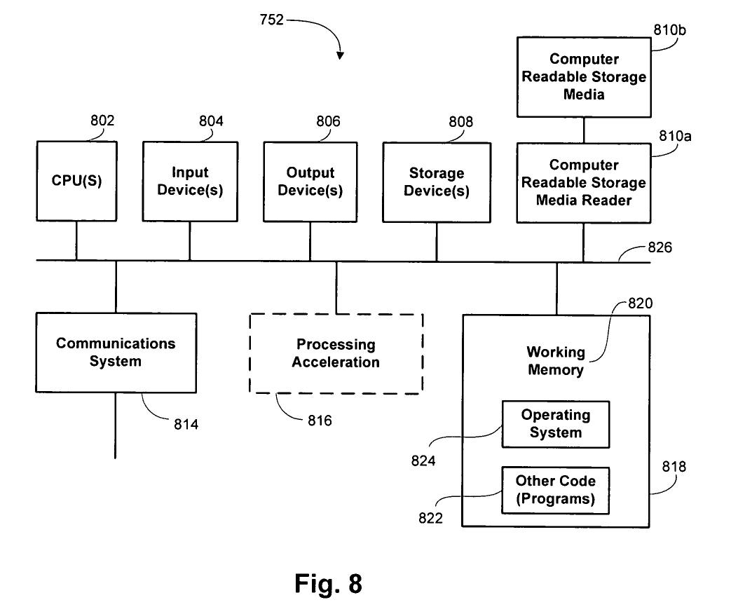

FIG. 8 provides a schematic illustration of a structure that may be used to implement the multi-aspect monitoring system 752. A similar structure may also be used to implement the modules described in connection with FIGS. 4 and 6. FIG. 8 broadly illustrates how individual system elements may be implemented in a separated or more integrated manner. The multi-aspect monitoring system 752 is shown comprised of hardware elements that are electrically coupled via bus 826, including a processor 802, an input device 804, an output device 806, a storage device 808, a computer-readable storage media reader 810a, a communications system 814, a processing acceleration unit 816 such as a DSP or special-purpose processor, and a memory 818. The computer-readable storage media reader 810a is further connected to a computer-readable storage medium 810b, the combination comprehensively representing remote, local, fixed, and/or removable storage devices plus storage media for temporarily and/or more permanently containing computer-readable information. The communications system 814 may comprise a wired, wireless, modem, and/or other type of interfacing connection and permits data to be exchanged with the active layer 748, databases 756, support network 760, and external interfaces 778.

The multi-aspect monitoring system 752 also comprises software elements, shown as being currently located within working memory 820, including an operating system 824 and other code 822, such as a program designed to implement methods of the invention. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

Thus, having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

1. A system for monitoring a state of an environment, the state being defined by a plurality of measured parameters, the system comprising:
a plurality of sensors distributed spatially within the environment, each such sensor being adapted to measure one of the measured parameters at its spatial location within the environment; and
a controller in communication with the sensors and having programming instructions to:
receive data collected from each of the sensors;
identify the occurrence of an event at at least one of the sensors by identifying a change in an event-defining parameter;
extract a plurality of derived parameters from the collected data;
determine a cross-correlation of the extracted plurality of derived parameters over the plurality of sensors; and
identify an abnormality in the environment from the determined cross-correlation.

2. The system recited in claim 1 wherein the event-defining parameter is the parameter measured at the at least one of the sensors.

3. The system recited in claim 1 wherein the event-defining parameter is derived from the parameter measured at the at least one of the sensors.

4. The system recited in claim 1 wherein:
the plurality of derived parameters each have a time dependence; and
the controller further has programming instructions to apply fuzzy logic to the time dependence of each of the derived parameters prior to determining the cross-correlation of the extracted plurality of derived parameters.

5. The system recited in claim 1 wherein:
the plurality of measured parameters are time-period correlatable; and
the programming instructions to extract the plurality of derived parameters comprise programming instructions to calculate an autocorrelation of each of the plurality of measured parameters.

6. The system recited in claim 1 wherein the plurality of derived parameters comprise a mean and standard deviation over time of the plurality of measured parameters.

7. The system recited in claim 1 wherein the environment comprises a hierarchical branching network with the plurality of sensors distributed throughout the hierarchical branching network.

8. The system recited in claim 7 wherein the environment comprises a fluid-distribution system and the hierarchical branching network comprises a network of branching channels through which fluid flows.

9. The system recited in claim 8 wherein the plurality of measured parameters comprise a quantity selected from the group consisting of a turbidity, a pH level, a conductivity, and a concentration of solids dissolved in the fluid.

10. The system recited in claim 7 wherein the environment comprises a power-distribution system and the hierarchical branching network comprises a network of branching power-distribution lines.

11. The system recited in claim 1 wherein the controller further has programming instructions to determine a severity of the abnormality from the determined cross-correlation.

12. The system recited in claim 11 wherein the controller further has programming instructions to initiate an alarm in accordance with the determined severity of the abnormality.

13. The system recited in claim 1 wherein:
the environment is one of a plurality of environments, each such environment having a state monitored by the system; and
the controller further has programming instructions to correlate abnormalities identified in each of the environments to provide a collective characterization of the plurality of environments.

14. A method for monitoring a state of an environment, the state being defined by a plurality of measured parameters, the method comprising:
receiving data collected from each of a plurality of sensors distributed spatially within the environment, the data providing a measurement of one of the measured parameters at a spatial location of a respective one of the sensors within the environment;
identifying the occurrence of an event at at least one of the sensors by identifying a change in an event-defining parameter;
extracting a plurality of derived parameters from the collected data;
determining a cross-correlation of the extracted plurality of derived parameters over the plurality of sensors; and
identifying an abnormality in the environment from the determined cross-correlation.

15. The method recited in claim 14 wherein the event-defining parameter is the parameter measured at the at least one of the sensors.

16. The method recited in claim 14 wherein the event-defining parameter is derived from the parameter measured at the at least one of the sensors.

17. The method recited in claim 14 wherein the plurality of derived parameters each have a time dependence, the method further comprising applying fuzzy logic to the time dependence of each of the derived parameters prior to determining the cross-correlation of the extracted plurality of derived parameters.

18. The method recited in claim 14 wherein:
the plurality of measured parameters are time-period correlatable; and
extracting the plurality of derived parameters comprises calculating an autocorrelation of each of the plurality of measured parameters.

19. The method recited in claim 14 wherein the plurality of derived parameters comprise a mean and standard deviation over time of the plurality of measured parameters.

20. The method recited in claim 14 wherein the environment comprises a hierarchical branching network with the plurality of sensors distributed throughout the hierarchical branching network.

21. The method recited in claim 20 wherein environment comprises a fluid-distribution system and the hierarchical branching network comprises a network of branching channels through which fluid flows.

22. The method recited in claim 21 wherein the plurality of measured parameters comprise a quantity selected from the group consisting of a turbidity, a pH level, a conductivity, and a concentration of solids dissolved in the fluid.

23. The method recited in claim 20 wherein the environment comprises a power-distribution system and the hierarchical branching network comprises a network a branching power-distribution lines.

24. The method recited in claim 14 further comprising determining a severity of the abnormality from the determined cross-correlation.

25. The method recited in claim 24 further comprising initiating an alarm in accordance with the determined severity of the abnormality.

26. The method recited in claim 14 wherein the environment is one of a plurality of environments, each such environment having a state, the method further comprising correlating abnormalities identified in each of the environments.

27. A system for monitoring a state of a fluid-distribution network having a network of branching channels through which fluid flows, the state being defined by a plurality of measured parameters, the system comprising:
a plurality of sensors distributed spatially throughout the network of branching channels, each such sensor being adapted to measure one of the measured parameters at its spatial location within the network of branching channels; and
a controller in communication with the sensors and having programming instructions to:
receive data collected from each of the sensors;
identify the occurrence of an event at at least one of the sensors by identifying a change in an event-defining parameter;
extract a plurality of derived parameters from the collected data, the plurality of derived parameters each having a time dependence;
apply fuzzy logic to the time dependence of each of the derived parameters;
determine a cross-correlation of the extracted plurality of derived parameters over the plurality of sensors after the fuzzy logic has been applied to the time dependence;
identify an abnormality in the fluid-distribution network from the determined cross-correlation; and
determining a severity of the abnormality from the determined cross-22 correlation.

28. The system recited in claim 27 wherein:
the plurality of measured parameters are time-period correlatable; and
the programming instructions to extract the plurality of derived parameters comprise programming instructions to calculate an autocorrelation of each of the plurality of measured parameters.

29. The system recited in claim 27 wherein the event-defining parameter is the parameter measured at the at least one of the sensors.

30. The system recited in claim 27 wherein the event-defining parameter is derived from the parameter measured at the at least one of the sensors.

31. The system recited in claim 27 wherein the plurality of measured parameters comprise a quantity selected from the group consisting of a turbidity, a pH level, a conductivity, and a concentration of solids dissolved in the fluid.

32. A method for monitoring a state of a fluid-distribution network having a network of branching channels through which fluid flows, the state being defined by a plurality of measured parameters, the method comprising:
receiving data collected from each of a plurality of sensors distributed spatially throughout the network of branching channels, the data providing a measurement of one of the measured parameters at its spatial location of a respective one of the sensors within the network of branching channels;
identifying the occurrence of an event at at least one of the sensors by identifying a change in an event-defining parameter;
extracting a plurality of derived parameters from the collected data, the plurality of derived parameters each having a time dependence;
applying fuzzy logic to the time dependence of each of the derived parameters;
determining a cross-correlation of the extracted plurality of derived parameters over the plurality of sensors after the fuzzy logic has been applied to the time dependence;
identifying an abnormality in the fluid-distribution network from the determined cross-correlation; and
determining a severity of the abnormality from the determined cross-correlation.

33. The method recited in claim 32 wherein:
the plurality of measured parameters are time-period correlatable; and
extracting the plurality of derived parameters comprises calculating an autocorrelation of each of the plurality of measured parameters.

34. The method recited in claim 32 wherein the event-defining parameter is the parameter measured at the at least one of the sensors.

35. The method recited in claim 32 wherein the event-defining parameter is derived from the parameter measured at the at least one of the sensors.

36. The method recited in claim 32 wherein the plurality of measured parameters comprise a quantity selected from the group consisting of a turbidity, a pH level, a conductivity, and a concentration of solids dissolved in the fluid.
